(19) United States
(12) Patent Application Publication
(10) Pub. No.: US 2004/0043221 A1
(43) Pub. Date: Mar. 4, 2004

(54) Method of adhering a film and articles therefrom

(75) Inventors: Vivek Bharti, West St. Paul, MN (US); Chih Chung Hsu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/231,570

(22) Filed: Aug. 30, 2002

(51) Int. Cl. B32B 31/00

(52) U.S. Cl. 428/409; 156/273.1

(57) ABSTRACT

A method for adhering a film to a substrate comprises providing an electret film having first and second opposed major surfaces, the electret film comprising a poly(ethylene-co-(meth)acrylic acid) ionomer; providing a substrate; and electrostatically and removably adhering the electret film to the substrate. Articles prepared according to the method are also disclosed.

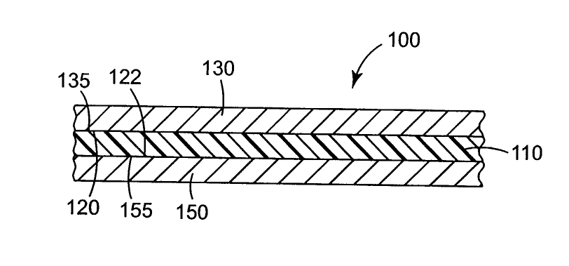

### TECHNICAL FIELD

The present invention generally relates to methods of electrostatically adhering a film to a substrate.

### BACKGROUND

The term “cling film” is commonly used to refer to a film that can cling to a substrate without the use of adhesives or fasteners. Cling films are generally divided into two major types: cling vinyl films and electret films.

Cling vinyl films (also known as “static cling vinyl” films) typically contain plasticizers and/or tackifiers, and can typically be adhered to smooth, rigid surfaces such as glass windows, but may not adhere well to porous, rough and/or dusty surfaces. In addition, plasticizers and/or tackifiers that are present in cling vinyl films may diffuse out of the film and leave a residue or on, or otherwise damage, a substrate to which the film is bonded.

In contrast, electret films (i.e., films having a permanent or semi-permanent electrostatic charge) typically adhere to surfaces by electrostatic attraction, typically do not require plasticizers or tackifiers, and may adhere well even to rough or dusty surfaces. Typically, electret films can be adhered to and removed (e.g., by peeling) from substrate surfaces, in some applications repeatedly, without causing significant damage to the electret film or the substrate. However, to date, the commercial success of electret films for cling film applications (e.g., those applications in which the electret film adheres to a vertical surface) has primarily been limited to those applications in which only short term and/or moderate cling is required.

The utility of electret films for cling applications typically depends, at least in part, on the initial adhesion (e.g., shear adhesion) of the electret film to the substrate, and the rate at which such adhesion changes over time. For example, a high initial adhesion between an electret film and a substrate (e.g., a vertically oriented substrate) that decays within a few hours or even days would be undesirable for applications requiring adhesion of the film to the substrate for periods of a week or longer.

Electret films have been prepared using a variety of thermoplastic polymers, and polypropylene electret films are commercially marketed as cling films. As manufactured, such polypropylene electret films initially have an acceptable level of cling to a substrate, but typically show a pronounced drop on the level of adhesion over time (e.g., weeks or months) that may lead to separation of the film from the substrate.

For cling film technology to be successful for applications requiring longer term and/or stronger adhesion (i.e., cling), it would be desirable to have electret films that exhibit a good level of adhesion to a variety of substrates for an extended period of time.

### SUMMARY

In one aspect, the present invention provides a method for adhering a film to a substrate comprising:

providing an electret film having first and second opposed major surfaces, the electret film comprising a poly(ethylene-co-(meth)acrylic acid) ionomer;

providing a substrate having a surface; and

electrostatically and removably adhering the first major surface of electret film to the surface of the substrate, wherein the surface of the substrate is substantially planar.

In another aspect, the present invention provides a method for adhering a film to a substrate comprising:

providing an electret film having first and second opposed major surfaces, the electret film comprising a poly(ethylene-co-(meth)acrylic acid) ionomer;

providing a substrate having a surface;

electrostatically and removably adhering the first major surface of electret film to the surface of the substrate; and

applying paint to the electret film and the substrate.

In another aspect, the present invention provides an article comprising:

an electret film having first and second opposed major surfaces, the electret film comprising a poly(ethylene-co-(meth)acrylic acid) ionomer; and

a substrate,

wherein the first major surface of the electret film is electrostatically and removably adhered to the substrate.

In another aspect, the present invention provides an article comprising:

an electret film having first and second opposed major surfaces, the electret film comprising a poly(ethylene-co-(meth)acrylic acid) ionomer; and

a first substrate; and

a second substrate,

wherein the first major surface of the electret film is electrostatically and removably adhered to the first substrate, and wherein the second major surface of the electret film is adhered to the second substrate.

In another aspect, the present invention provides a method for adhering a film to a substrate comprising:

providing an electret film having first and second opposed major surfaces, the electret film comprising a poly(ethylene-co-(meth)acrylic acid) ionomer;

providing a substrate having a surface; and

electrostatically and removably adhering the first major surface of electret film to the surface of the substrate, wherein the substrate is selected from the group consisting of a backing sheet, a multilayer optical film, a ceiling, a wall, a floor, a window, a mirror, drywall, plaster, a motor vehicle, a trailer, a mobile home, a boat, furniture, a box, a cabinet, a door, ceramic tile, a banner, a balloon, a sign, paper, and cloth.

In another aspect, the present invention provides an article comprising:

an electret film having first and second opposed major surfaces, the electret film comprising a poly(ethylene-co-(meth)acrylic acid) ionomer; and

a substrate, wherein the first major surface of the electret film is electrostatically and removably adhered to the substrate, wherein the substrate is selected from the group consisting of a backing sheet, a multilayer optical film, a ceiling, a wall, a floor, a window, a mirror, drywall, plaster, a motor vehicle, a trailer, a mobile home, a boat, furniture, a box, a cabinet, a door, ceramic tile, a banner, a balloon, a sign, paper, and cloth.

Electret films comprising poly(ethylene-co-(meth)acrylic acid) ionomers typically adhere well (e.g., as measured by static shear adhesion) to a variety of substrates, and maintain good levels of adhesion to such substrates over extended periods of time.

As used herein:

“film” refers to a continuous nonporous thin layer, and includes for example, rolls, sheets, tapes, and strips;

“removably adhered” means separable by peeling, without substantial damage (e.g., tearing) to the objects being separated;

“(meth)acryl” includes acryl and methacryl; and

“ionomer” refers to a polymer having carboxyl groups wherein at least some of the acidic protons have been replaced (i.e., neutralized) by metal ions.

### BRIEF DESCRIPTION OF THE DRAWING

The drawing is a cross-sectional view of an exemplary article according to one embodiment of the present invention.

### DETAILED DESCRIPTION

Electret films used in practice of the present invention typically comprise at least one poly(ethylene-co-(meth)acrylic acid) ionomer.

Useful poly(ethylene-co-(meth)acrylic acid) ionomers include copolymers of ethylene and (meth)acrylic acid that are partially or fully neutralized with metal cations from Groups 1 to 12 (e.g., Li⁺, Na⁺, K⁺, Ca²⁺, Mg²⁺, Fe³⁺, Zn²⁺), or a mixture thereof. Preferably, the metal cation is an alkali metal cation, an alkaline earth cation, a zinc cation, or a mixture thereof. More preferably, the metal cation is Li⁺, Na⁺, Mg²⁺, or Zn²⁺, or a mixture thereof.

Preferably, the (meth)acrylic acid monomer unit content (i.e., free acid form) of the poly(ethylene-co-(meth)acrylic acid) ionomer is in a range of from about 2 percent by weight to about 25 percent by weight, more preferably in a range of from about 5 percent by weight to about 20 percent by weight, more preferably in a range of from about 7 percent by weight to about 15 percent by weight, based on the total weight of the ionomer, although higher and lower amounts may be used.

Typically, the degree of neutralization of the (meth)acrylic acid monomer units of useful poly(ethylene-co-(meth)acrylic acid) ionomers is in a range of from about 0.01 equivalent to about 1 equivalent of metal cation per equivalent of (meth)acrylic acid monomer unit, preferably in an amount in a range of from about 0.1 equivalent to about 0.8 equivalent of metal cation per equivalent of (meth)acrylic acid monomer unit, more preferably in an amount in a range of from about 0.1 equivalent to about 0.7 equivalent of metal cation per equivalent of (meth)acrylic acid monomer unit, more preferably in an amount in a range of from about 0.1 equivalent to about 0.5 equivalent of metal cation per equivalent of (meth)acrylic acid monomer unit, more preferably in an amount in a range of from about 0.1 equivalent to about 0.2 equivalent of metal cation per equivalent of (meth)acrylic acid monomer unit.

Poly(ethylene-co-(meth)acrylic acid) ionomers can be made by known methods as described in, for example, U.S. Pat. No. 3,264,272 (Rees), U.S. Pat. No. 3,845,163 (Murch), and U.S. Pat. No. 5,198,301 (Hager et al.), the disclosures of which are incorporated herein by reference.

Optionally, one or more additional free-radically polymerizable monomers (e.g., monofunctional acrylate monomers (e.g., alkyl (meth)acrylates whose alkyl groups have from 1 to about 8 carbon atoms), N-vinyl monomers, alpha-olefin monomers) may be copolymerized into the backbone of the ionomer, for example, in order to adjust physical properties of the ionomer for a specific intended application. If present, the amount of additional free-radically polymerizable monomer is preferably less than about 40 percent by weight, more preferably in an amount of less than about 15 percent by weight, more preferably in an amount of less than about 5 percent by weight, based on the total weight of the ionomer, although other amounts may also be used.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930” or “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, or “SURLYN 8945”; zinc poly(ethylene-co-methacrylic acid) ionomers such as “SURLYN 1652”, “SURLYN 1705-1”, “SURLYN 1706”, SURLYN 6101”, SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, or “SURLYN PC-100”) by E. I. du Pont de Nemours & Company, Wilmington, Del.; or as marketed under the trade designation “IOTEK” (e.g., sodium poly(ethylene-co-acrylic acid) ionomers such as “IOTEK 3110”, “IOTEK 3800”, or “IOTEK 8000”, and zinc poly(ethylene-co-acrylic acid) ionomers such as “IOTEK 4200”) by ExxonMobil Corporation, Houston, Tex.

Optionally, poly(ethylene-co-(meth)acrylic acid) ionomers may be used as a blend with one or more additional thermoplastic polymers (e.g., polyamides, polyolefins (e.g., polypropylene), polystyrene, polyesters, polyurethanes) and/or ionomers.

Poly(ethylene-co-(meth)acrylic acid) ionomers in pellet form may typically be compounded with one or more optional components (e.g., additives and/or polymers), and melt-extruded as a film using procedures well known in the film art.

Exemplary optional additives include antioxidants, light stabilizers (e.g., as available from Ciba Specialty Chemicals, Tarrytown, N.Y., under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. No. 5,976,208 (Rousseau et al.) and U.S. Pat. No. 6,397,458 (Jones et al.)), glass beads, glass bubbles, colorants (e.g., dyes, pigments (including phosphorescent pigments), and fragrances.

Exemplary optional additives also include titanium dioxide (e.g., in particulate form). If present, the amount of titanium dioxide preferably is in a range of from about 1 to about 50 percent by volume, more preferably in a range of from about 1 to about 20 percent by volume, based on the total volume of the film, although greater and lesser amounts of titanium dioxide particles may also be used.

The electret film may be a unitary film (i.e., a single layer) or it may comprise multiple securely bonded layers (e.g., bonded through heat lamination, adhesively bonded, and/or coextruded). Exemplary layers that may form all, or part of, the electret film include thermoplastic optical films and/or image-receiving layers. The electret film may be opaque, transparent, or translucent, and may have distinct regions of differing opacity. The electret film may be perforated.

Preferably, the electret film is free of tackifiers and/or plasticizers.

Typically, electret films used in practice of the present invention have a thickness in a range of from about 10 to about 2500 micrometers, although thinner and thicker films may also be used. Preferably, electret films have a thickness in the range of from about 25 to about 310 micrometers, more preferably in the range of from about 50 to about 110 micrometers.

The electret film may optionally have an image on at least one major surface thereof. The image may comprise, for example, at least one graphic image, alphanumeric character, and/or other indicia. The image may be printed (e.g., by inkjet printing, electro(photo)graphy, letter press, flexography, thermal transfer printing, screen printing, lithographic printing) or created by other means (e.g., laser marking). Optionally, an image-receiving layer may be coated on, or otherwise affixed to, at least a portion of the electret film. Such a layer may be applied to an entire major surface of the electret film, or only a portion thereof. The optional image may, for example, be disposed on the outermost surface of, and/or contained within, the image-receiving layer.

Preferably, the electret is formed (e.g., by direct current (i.e., DC) corona charging) subsequent to any printing, coating, and/or heat lamination steps that may be involved in producing articles according to the present invention, although the electret may be formed at other stages of the manufacturing process.

Electret formation can be accomplished by a variety of methods that are well known in the art. For details on methods for making electret films see, for example, “Electrets”, G. M. Sessler (ed.), Springer-Verlag, New York, 1987. Exemplary methods of forming electrets are well known in the art, and include thermal electret, electroelectret, radioelectret, magnetoelectret, photoelectret and mechanical electret forming methods as described in, for example, U.S. Pat. No. 5,558,809 (Groh et al.), the disclosure of which is incorporated herein by reference. Typically, electret films utilized in practice of the present invention have a charge (i.e., electret charge) density of greater than about 0.05 nanocoulombs per square centimeter (nC/cm²), preferably greater than about 0.5 nC/cm², more preferably greater than about 5 nC/cm². DC corona charging (e.g., using direct current as described in, for example, U.S. Pat. No. 6,001,299 (Kawabe et al.) and U.S. Pat. No. 4,623,438 (Felton et al.), the disclosures of which are incorporated herein by reference) is a preferred method for preparing electret films of the present invention.

In some embodiments of the present invention, such as those in which strong bonding is undesirable (e.g., bonding to fragile substrates), it is preferable that one or more surfaces of the electret film be free of adhesive or latent adhesive that might adhere to the substrate over time. Such adhesion may lead to unwanted adhesive residues and/or damage upon separation of the electret film from the substrate.

According to one embodiment of the present invention, electret films useful in practice of the present invention may typically be contacted with a substrate, thereby electrostatically and removably adhering them to that substrate.

Referring now to the drawing, article 100 comprises electret film 110 with first and second major opposed surfaces 120 and 122, respectively. Surface 135 of first substrate 130 is electrostatically and removably adhered to first major surface 120. Surface 155 of optional second substrate 150 contacts second major surface 122. Preferably, optional second substrate 150 and second major surface 122 are electrostatically and removably adhered to each other.

Any solid substrate may be used in practicing the present invention. The substrate may be conductive or nonconductive. Preferably, at least the portion of the surface of the substrate that contacts the article is substantially planar. As used herein, the term “substantially planar” encompasses surfaces that are generally planar in appearance, optionally having minor irregularities, imperfections and/or warpage. Suitable substrates may have vertical and/or horizontal surfaces, and may be painted or unpainted. Exemplary substrates include liners (e.g., papers, thermoplastic polymer films); multilayer optical films (e.g., as described in for example U.S. Pat. No. 5,825,543 (Ouderkirk et al.) and U.S. Pat. No. 5,783,120 (Ouderkirk et al.), the disclosures of which are incorporated by reference), architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, furniture (e.g., wicker furniture), boxes, cabinets, mats, wall hangings, doors, dishes (e.g., glasses, plates, and ceramic dishes), ceramic tile, photographs, banners, balloons, signs, paper, and cloth. Preferably, the substrate is non-conductive (i.e., a dielectric), although this is not a requirement.

Articles of the present invention (e.g., a poly(ethylene-co-(meth)acrylic acid) ionomer electret film on a substrate) have many practical uses that take advantage of the outstanding cling properties of electret films according to the teachings herein. For example, articles of the present invention may be useful as a memo board, wherein papers, cards, and such may be adhered to an electret film that is removably adhered to a vertical surface. In another application, articles of the present invention may be useful as a projection screen (e.g., as a portable screen) for displaying a projected image.

Typically, the electret film may be removably adhered to a substrate by contacting a major surface of the electret film with a surface of the substrate, sliding the electret film to a desired orientation and/or position, and then smoothing out wrinkles and/or bubbles in the film. After smoothing, the electret film is preferably rubbed (e.g., with a woven or nonwoven cloth) as described in commonly assigned U.S. Pat. Appl. entitled “METHOD FOR ELECTROSTATICALLY ADHERING AN ARTICLE TO A SUBSTRATE” (Bharti et al.), bearing Attorney Case No. 57949US002, filed concurrently herewith, the disclosure of which is incorporated herein by reference. Such rubbing typically serves to increase the level of shear adhesion between the electret film and the substrate.

To assure good cling properties, electret films used in practice of the present invention are preferably capable of conforming to the surface of a substrate to which they are adhered. In some embodiments of the present invention, this may be achieved using electret films having a 1% secant modulus (as measured according to ASTM D882-02 (2002), “Standard Test Method for Tensile Properties of Thin Plastic Sheeting”) in a range of from about 40 megapascals (MPa) to about 500 MPa, more preferably in a range of from about 100 MPa to about 400 MPa, more preferably in a range of from about 150 MPa to about 300 MPa.

Similarly, to aid in adhesion, surface roughness of the film is preferably minimized. Thus, electret films used in practice of the present invention preferably have a surface roughness Ra (i.e., the average of the absolute distance between the middle value and the actual surface) of less than about 200 nanometers (nm), preferably less than about 150 nm, more preferably less than about 100 nm. Ra can be readily determined by optical interferometry, for example, using commercially available equipment such that marketed by Veeco Instruments, Woodbury, N.Y., under the trade designation “WYKO HD3300 HEAD MEASUREMENT SYSTEM”.

Typically, useful poly(ethylene-co-(meth)acrylic acid) ionomers have a melt flow index as measured according to ASTM D-1238 (condition E) in a range of from about 0.5 grams/10 minutes (i.e., 0.5 g/10 min) to about 100 g/10 min, preferably in a range of from about 0.8 g/10 min to about 20 g/10 min, more preferably in a range of from about 0.8 g/10 min to about 5 g/10 min, although other melt flow indices may also be useful.

Electret films comprising poly(ethylene-co-(meth)acrylic acid) ionomers, typically exhibit tight bonding to the surfaces of substrates. Accordingly, they may be well-suited for use as a masking film for use during application of paint to a substrate. In such applications, the electret film is typically applied to the surface of a substrate adjacent to a region of the substrate to be painted. Next, paint is typically applied to the substrate and at least a portion of the electret film. After the paint has been applied, the masking film may be removed, and reused or discarded. Because of the tight bonding, such masking procedures are typically effective for preventing seepage of paint beneath the masking film. Exemplary methods for applying paint include spraying, brushing, and by roller.

In some embodiments of the present invention, such as those in which resistance to marking (e.g., dirt or graffiti) is desired, articles containing the electret film can be modified by plasma fluorination. Plasma fluorination is a technique whereby fluorine atoms are chemically bonded to the surface of a polymeric material resulting in a lowered surface energy of the article and typically imparting an electret charge to that material. A description of the plasma fluorination process is described in, for example, U.S. Pat. No. 6,397,458 (Jones et al.), the disclosure of which is incorporated herein by reference.

The present invention will be more fully understood with reference to the following non-limiting examples in which all parts, percentages, ratios, and so forth, are by weight unless otherwise indicated.

### EXAMPLES

In the following examples, ambient conditions were temperatures in a range of from 21° C. to 23° C., with relative humidity in a range of from 10 percent to 70 percent. In Tables 1 and 2, “NM” means not measured.

The following films were used in the examples that follow:

FILM A was prepared by extruding a zinc poly(ethylene-co-methacrylic acid) ionomer (obtained as pellets under the trade designation “SURLYN 1706” from E. I. du Pont de Nemours & Company, Wilmington, Del.), and was extruded using a single screw extruder onto a polyester liner (1.4 mil (36 micrometers) thick, polyethylene terephthalate containing 0.5 percent by weight aluminum silicate) to obtain an extruded film with a thickness of 2 mils (50 micrometers). The total thickness of film and liner was 3.4 mils (86 micrometers). The following physical properties are reported by the manufacturer for “SURLYN 1706” ionomer: Melt Flow Index=6.5 dg/min by ASTM D1238 (Condition E); Melt Point=90° C. by ASTM D3418 (DSC); Vicat Softening Point=65° C. by ASTM D1525; 2.0 mil (51 micrometers) film properties, 1% secant modulus by ASTM D882, MD=49000 psi (340 MPa), TD=53000 psi (365 MPa).

FILM B was prepared by extruding a sodium poly(ethylene-co-methacrylic acid) ionomer (obtained as pellets under the trade designation “SURLYN PC 100” from E. I. du Pont de Nemours & Company), and was extruded using a single screw extruder onto a polyester liner (1.4 mil (36 micrometers) thick, polyethylene terephthalate containing 0.5 percent by weight aluminum silicate) to obtain an extruded film with a thickness of 2 mils (50 micrometers).). The total thickness of film and liner was 3.4 mils (86 micrometers). The following physical properties are reported by the manufacturer for “SURLYN PC 100” ionomer: Melt Flow Index=0.9 dg/min by ASTM D1238 (Condition E); Melt Point=88° C. by DSC; Vicat Softening Point=45° C. by ASTM D1525.

FILM C was prepared by extruding a mixture of 78 parts of a zinc poly(ethylene-co-methacrylic acid) ionomer (obtained as pellets under the trade designation “SURLYN 1705-1” from E. I. du Pont de Nemours & Company) with 22 parts of a dispersion of 15.4 parts titanium dioxide in 6.6 parts polyethylene (obtained under the trade designation “STANDRIDGE 11937 WHITE CONCENTRATE” from Standridge Color, Bridgewater, N.J.) using a single screw extruder onto a 2 mils (50 micrometers) thick polyester liner to obtain an extruded film with a thickness of 3 mils (80 micrometers). The total thickness of film and liner was 5 mils (130 micrometers). The following physical properties are reported by the manufacturer for “SURLYN 1705-1” ionomer: Melt Flow Index=4.80 dg/min by ASTM D1238 (Condition E); Melting Point=94° C.; Vicat Softening Point=65° C. by ASTM D1525; 2.0 mil (51 micrometers) film properties, 1% secant modulus by ASTM D882, MD=35000 psi (240 MPa), TD=34000 psi (234 MPa).

FILM D was a 2 mils (50 micrometers) thickness film of extruded sodium poly(ethylene-co-methacrylic acid) ionomer (available under trade designation “SURLYN 1601” from E. I. du Pont de Nemours & Company) obtained from Flex-O-Glass, Chicago, Ill. The following physical properties are reported by the manufacturer for “SURLYN 1601” ionomer: Melt Flow Index=1.30 dg/min by ASTM D1238 (Condition E); Melting Point=98° C.; Vicat Softening Point=74° C. by ASTM D1525; 2.0 mils (51 micrometers) film properties, 1% secant modulus by ASTM D882, MD=35000 psi (240 MPa), TD=38000 psi (262 MPa).

FILM E was a 7.5 mils (190 micrometers) thickness film of extruded sodium poly(ethylene-co-methacrylic acid) ionomer (available under trade designation “SURLYN 1901” from E. I. du Pont de Nemours & Company) obtained from Flex-O-Glass. The following physical properties are reported by the manufacturer for “SURLYN 1901” ionomer: Melt Flow Index=1.30 dg/min by ASTM D1238 (Condition E); Melting Point=95° C.; Vicat Softening Point=70° C. by ASTM D1525; 2.0 mils (51 micrometers) film properties, 1% secant modulus by ASTM D882, MD=24100 psi (166 MPa), TD=23600 psi (163 MPa).

FILM F was a 4 mils (100 micrometers) thickness film of extruded sodium poly(ethylene-co-methacrylic acid) ionomer (available under trade designation “SURLYN HP2000” from E. I. du Pont de Nemours & Company) obtained from Flex-O-Glass.

FILM G was a 3-layer biaxially oriented (7 by 7) film made by simultaneous 3-layer extrusion. The two outer layers had a thickness of 0.005 mils (0.1 micrometers) and consisted of polypropylene (obtained under the trade designation “FINA-3376” from Atofina Petrochemicals, Houston, Tex.). The central layer consisted of 5 percent by weight titanium dioxide in 95 percent by weight polypropylene (“FINA-3376”). The total film thickness was 1.85 mils (47 micrometers).

FILM H was a 2 mils (50 micrometers) thickness film of extruded zinc poly(ethylene-co-methacrylic acid) ionomer (available under trade designation “SURLYN 1652” from E. I. du Pont de Nemours & Company) obtained from Flex-O-Glass. The following physical properties are reported by the manufacturer for “SURLYN 1652” ionomer: Melt Flow Index=5.2 dg/min by ASTM D1238 (Condition E); Melt Point=100° C.; Vicat Softening Point=79° C. by ASTM D1525; 2.0 mil film properties, 1% secant modulus by ASTM D882, MD=22000 psi (150 MPa), TD=23000 psi (160 MPa).

FILM I was prepared by extruding (single screw extruder) zinc poly(ethylene-co-methacrylic acid) ionomer (obtained as pellets under the trade designation “SURLYN 1705-1” from E. I. du Pont de Nemours & Company) onto a polyester liner (1.4 mil (36 micrometers) thick, polyethylene terephthalate containing 0.5 percent by weight aluminum silicate) to obtain a film with a thickness of 3 mils (75 micrometers).

FILM J was prepared by extruding a mixture of 96.805 parts zinc poly(ethylene-co-methacrylic acid) ionomer (obtained as pellets under the trade designation “SURLYN 1706” from E. I. du Pont de Nemours & Company, Wilmington, Del.), 1.35 parts of light stabilizer ((obtained under the trade designation “TINUVIN 328” from Ciba Specialty Chemicals), 0.9 parts 2-hydroxy-4-(octyloxy)benzophenone (obtained under the trade designation “LOWILITE 22” from Great Lakes Chemical Corporation, Indianapolis, Ind.), 0.9 parts of a hindered amine light stabilizer (obtained under the trade designation “CHIMMASORB 944” from Ciba Specialty Chemicals), 0.045 parts of a heat stabilizer obtained under the trade designation “IRGANOX 1010” from Ciba Specialty Chemicals) using a single screw extruder onto a polyester liner (1.4 mil (36 micrometers) thick, polyethylene terephthalate containing 0.5 percent by weight aluminum silicate) to obtain a film with a thickness of 3 mils (75 micrometers). The total thickness of film and liner was 4.4 mils (110 micrometers).

FILM K was prepared by extruding (single screw extruder) sodium poly(ethylene-co-acrylic acid) ionomer (obtained as pellets under the trade designation “IOTEK 3110” ExxonMobil Corporation, Irving, Tex.) to obtain a film with a thickness of 3 mils (75 micrometers). The following physical properties are reported by the manufacturer for “IOTEK 3110” ionomer: Melt Flow Index=1.3 dg/min by ASTM D1238; Melting Point=94° C.; Vicat Softening Point=73° C. by ASTM D1525; 2.0 mil film properties, 1% secant modulus by ASTM D638, MD=220 MPa, TD=200 MPa.

FILM L was prepared by extruding (single screw extruder) zinc poly(ethylene-co-acrylic acid) ionomer (obtained as pellets under the trade designation “IOTEK 4200” from ExxonMobil Corporation, Irving, Tex.) to obtain a film with a thickness of 3 mils (80 micrometers). The following physical properties are reported by the manufacturer for “IOTEK 4200” ionomer: Melt Flow Index=3 dg/min by ASTM D1238; Melting Point=94° C.; Vicat Softening Point=73° C. by ASTM D1525; 2.0 mil film properties, 1% secant modulus by ASTM D638, MD=130 MPa, TD=140 MPa.

FILM M was prepared by extruding (single screw extruder) sodium poly(ethylene-co-acrylic acid) ionomer (obtained as pellets under the trade designation “IOTEK 8000” from ExxonMobil Corporation, Irving, Tex.) to obtain a film with a thickness of 3 mils (80 micrometers). The following physical properties are reported by the manufacturer for “IOTEK 8000” ionomer: Melt Flow Index=0.8 dg/min by ASTM D1238; Melting Point=83° C.; Vicat Softening Point=54° C. by ASTM D1525.

FILM N was polypropylene film having an electret charge commercially available under the trade designation “CLINGZ” from Permacharge Corporation, Rio Rancho, N. Mex.

Shear Adhesion Test

Three test strips, measuring 2 inches by 4 inches (5.1 cm by 10.2 cm) were cut from each sample of film. The test strips were adhered to a vertically oriented surface of 40-point white paperboard (obtained under the trade designation “CRESCENT PAPERBOARD” obtained from Unisource Worldwide Company, Brooklyn Park, Minn.) that had been painted with eggshell finish latex paint (“EGGSHELL ULTRA WHITE, #110-07”, pigmented according to the “SANDY OASIS” color standard obtained from Dutch Boy, Cleveland, Ohio) and adhered using spray adhesive (obtained under the trade designation “SPRA-MENT ART & DISPLAY ADHESIVE” from 3M Company to a 5 inches×8 inches×0.25 inch (13 cm×20 cm×0.6 cm) unpainted basswood panel. A piece of tape (¾ inch (1.9 cm) width, obtained under the trade designation “SCOTCH MAGIC TRANSPARENT TAPE” from 3M Company) was vertically adhered to the top edge of the film and fastened to a cross-head of a tensile testing machine (obtained under the trade designation “SINTECH 200/S” from MTS Systems Corporation, Cary, N.C.), such that force was applied parallel to the 10.2 cm edges of the film piece. The panel and film assembly was vertically oriented such that the 5.1 cm edges of the film were positioned at the top and bottom of the film. The force necessary to cause movement of the film relative to the panel (i.e., shear adhesion) was determined using a cross-head speed of 2.5 cm/min.

The test strip was sequentially applied to the test panel and removed by shearing as described above a total of 5 times. The initial shear adhesion and the average shear adhesion of the third, fourth, and fifth measurements combined (i.e., repeated shear) were reported in grams/inch (i.e., g/in).

General Method for Preparing Charged Samples

Film samples (8.5 inches×11 inches (22 cm×28 cm), with any associated liner removed) were DC corona charged under ambient conditions using a horizontally arranged series of four charging bars (obtained under the trade designation “CHARGEMASTER PINNER ARC RESISTANT CHARGING BAR” from Simco Company, Hatfield, Pennsylvania. The charging bars were spaced as follows: the center to center distance betweem bar 1 and bar 2 was 3.0 inches (7.6 cm), the center to center distance between bar 2 and bar 3 was 3.25 inches (8.3 cm), and the center to center distance between bar 3 and bar 4 was 3.75 inches (9.5 cm). Each charging bar was situated 1.5 inches (3.5 cm) above a corresponding grounded metal plate. A voltage of +29 kilovolts (relative to the grounded metal plates) was applied to each charging bar. Film samples were charged by placing them on a moving (one foot per minute (1.8 meters per minute)) continuous belt (part number: 8882802A, obtained from Light Weight Belting Corporation, Minneapolis, Minnesota) that passed between the charging bars and the metal plates, such that the belt maintained contact with the metal plates.

### Examples 1-12 and Comparative Examples A-B

Film samples (except Film N) were prepared and charged as described in the General Method for Preparing Charged Samples. The film samples were evaluated for shear adhesion according to the Shear Adhesion Test with the following modification: during the Shear Adhesion Test each test strip was sequentially applied to the test panel and removed by shearing as described above for a total of 5 times. The initial shear adhesion and the average shear adhesion of the third, fourth, and fifth measurements combined (i.e., repeated shear adhesion) were determined and are reported in Table 1 (below).

TABLE 1

| | | | | | | Repeated | |
|---|---|---|---|---|---|---|---|
| | | Before | | Initial Shear | | Shear | |
| | | Charging, | | Adhesion, | | Adhesion, | |
| EXAMPLE | FILM | g/in (g/cm) | | g/in (g/cm) | | g/in (g/cm) | |
| Comparative A | G | NM | | 117 | (46.1) | 77 | (30) |
| Comparative B | N | NM | | 81 | (32) | 33 | (13) |
| 1 | A | 23 | (9.1) | 175 | (68.9) | 122 | (48.0) |
| 2 | B | 24 | (9.4) | 182 | (7.1) | 33 | (13) |
| 3 | C | 3 | (0.1) | 240 | (94.5) | 216 | (85.0) |
| 4 | D | 7 | (3) | 120 | (47.2) | 75 | (30) |
| 5 | E | 11 | (4.3) | 55 | (22) | 30 | (12) |
| 6 | F | 14 | (5.5) | 147 | (57.9) | 29 | (11) |
| 7 | H | 4 | (2) | 93 | (37) | 66 | (26) |
| 8 | I | 29 | (11) | 114 | (44.9) | 104 | (40.9) |
| 9 | J | 20 | (7.9) | 323 | (127) | 240 | (94.5) |
| 10 | K | 16 | (6.3) | 369 | (145) | 73 | (28.7) |
| 11 | L | 18 | (7.1) | 413 | (163) | 102 | (40.2) |
| 12 | M | 18 | (7.1) | 286 | (113) | 44 | (17) |

### Examples 13-15 and Comparative Examples C—H

Samples of corona charged Films C, J, G, and N were placed into several stacks, such that each stack contained one piece of each charged Film C, J, G, and N was separated from adjacent charged films by a piece of uncharged 2 mils (50 micrometers) thick polyethylene terephthalate film. The stacks of charged films were placed in cardboard boxes, and subjected to various aging conditions (i.e., 90° F. (32° C.)/90 percent relative humidity, 120° F. (49° C.)/ambient humidity, and 73° F. (23° C.)/50 percent relative humidity. The Shear Adhesion Test was periodically performed on the aged samples. Results of testing (each entry representing an average of nine individual measurements) are reported in Table 2 (below).

TABLE 2

| | | | Shear Adhesion, g/inch (g/cm) | | | | |
|---|---|---|---|---|---|---|---|
| | | | | Immediately | | | |
| | | Conditions | Before | after | 1 | 3 | 6 |
| EXAMPLE | FILM | ° C./R. H. | Charging | Charging | Month | Months | Months |
| Comparative | G | 23/50 | 0.6 (0.2) | 79 (31) | 67 | 44 (17) | 44 (17) |
| C | | | | | (26) | | |
| Comparative | G | 32/90 | 0.6 (0.2) | 79 (31) | 83 | 26 (10) | 35 (14) |
| D | | | | | (33) | | |
| Comparative | G | 49/ambient | 0.6 (0.2) | 79 (31) | 25 | 15 | 20 |
| E | | | | | (9.8) | (5.9) | (7.9) |
| Comparative | N | 23/50 | NM | 28 (11) | 23 | 14 | 10 |
| F | | | | | (9.1) | (5.5) | (3.9) |
| Comparative | N | 32/90 | NM | 28 (11) | 17 | 12 | 16 |
| G | | | | | (6.7) | (4.7) | (6.3) |
| Comparative | N | 49/ambient | NM | 28 (11) | 10 | 13 | 6 (3) |
| H | | | | | (3.9) | (5.1) | |
| 13 | J | 23/50 | 20 (7.9) | 215 (84.6) | 202 | 140 | 55 (22) |
| | | | | | (79.5) | (55.1) | |
| 14 | J | 32/90 | 20 (7.9) | 215 (84.6) | 196 | 104 | 134 |
| | | | | | (77.1) | (40.9) | (52.8) |
| 15 | J | 49/ambient | 20 (7.9) | 215 (84.6) | 109 | 71 (28) | 50 (20) |
| | | | | | (42.9) | | |

Various modifications and alterations of this invention will become apparent to those skilled in the art without departing from the scope and spirit of this invention, and it should be understood that this invention is not to be unduly limited to the illustrated embodiments set forth herein.

What is claimed is:

1. A method for adhering a film to a substrate comprising:
providing an electret film having first and second opposed major surfaces, the electret film comprising a poly(ethylene-co-(meth)acrylic acid) ionomer;
providing a substrate having a surface; and
electrostatically and removably adhering the first major surface of electret film to the surface of the substrate, wherein the surface of the substrate is substantially planar.

2. The method of claim 1, wherein the poly(ethylene-co-(meth)acrylic acid) ionomer comprises at least one of zinc, sodium, magnesium, or lithium.

3. The method of claim 1, wherein the (meth)acrylic acid monomer unit contents of the poly(ethylene-co-(meth)acrylic acid) ionomer is in a range of from about 2 percent by weight to about 20 percent by weight, based on the total weight of the ionomer.

4. The method of claim 1, wherein the (meth)acrylic acid monomer unit contents of the poly(ethylene-co-(meth)acrylic acid) ionomer is in a range of from about 7 percent by weight to about 15 percent by weight, based on the total weight of the ionomer.

5. The method of claim 1, wherein the ratio of metal ions to (meth)acrylic acid monomer units comprising the poly(ethylene-co-(meth)acrylic acid) ionomer is in a range of from about 0.1 equivalent to about 0.5 equivalent of metal cation per equivalent of (meth)acrylic acid monomer unit.

6. The method of claim 1, wherein the molar ratio of metal ions to (meth)acrylic acid units comprising the poly(ethylene-co-(meth)acrylic acid) ionomer is in a range of from about 0.1 equivalent to about 0.2 equivalent of metal cation per equivalent of (meth)acrylic acid monomer unit.

7. The method of claim 1, wherein the poly(ethylene-co-(meth)acrylic acid) ionomer has a 1% secant modulus according to ASTM D882-02 in a range of from about 40 MPa to about 500 MPa.

8. The method of claim 1, wherein the poly(ethylene-co-(meth)acrylic acid) ionomer has a 1% secant modulus according to ASTM D882-02 in a range of from about 100 MPa to about 400 MPa.

9. The method of claim 1, wherein the poly(ethylene-co-(meth)acrylic acid) ionomer has a 1% secant modulus according to ASTM D882-02 in a range of from about 150 MPa to about 300 MPa.

10. The method of claim 1, wherein the first substrate comprises a backing sheet.

11. The method of claim 1, wherein the first substrate is selected from the group consisting of a backing sheet, an architectural surface, glass, and a motor vehicle.

12. A method for adhering a film to a substrate comprising:
providing an electret film having first and second opposed major surfaces, the electret film comprising a poly(ethylene-co-(meth)acrylic acid) ionomer;
providing a substrate having a surface;
electrostatically and removably adhering the first major surface of electret film to the surface of the substrate; and
applying paint to the electret film and the substrate.

13. The method of claim 12, wherein applying comprises spraying.

14. The method of claim 12, further comprising separating the electret film and the substrate.

15. The method of claim 12, wherein the substrate is selected from the group consisting of an architectural surface and a motor vehicle.

16. The method of claim 1, further comprising:
providing a second substrate; and
electrostatically and removably adhering the second surface of the electret film to the second substrate.

17. The method of claim 1, wherein the second substrate is paper or thermoplastic film.

18. An article comprising:
an electret film having first and second opposed major surfaces, the electret film comprising a poly(ethylene-co-(meth)acrylic acid) ionomer; and
a substrate,
wherein the first major surface of the electret film is electrostatically and removably adhered to the substrate.

19. The article of claim 18, wherein the poly(ethylene-co-(meth)acrylic acid) ionomer comprises at least one of zinc, sodium, magnesium, or lithium.

20. The article of claim 18, wherein the (meth)acrylic acid monomer unit contents of the poly(ethylene-co-(meth)acrylic acid) ionomer is in a range of from about 2 percent by weight to about 20 percent by weight, based on the total weight of the ionomer.

21. The article of claim 18, wherein the (meth)acrylic acid monomer unit contents of the poly(ethylene-co-(meth)acrylic acid) ionomer is in a range of from about 7 percent by weight to about 15 percent by weight, based on the total weight of the ionomer.

22. The article of claim 18, wherein the ratio of metal ions to (meth)acrylic acid monomer units comprising the poly(ethylene-co-(meth)acrylic acid) ionomer is in a range of from about 0.1 equivalent to about 0.5 equivalent of metal cation per equivalent of (meth)acrylic acid monomer unit.

23. The article of claim 1 8, wherein the molar ratio of metal ions to (meth)acrylic acid units comprising the poly(ethylene-co-(meth)acrylic acid) ionomer is in a range of from about 0.1 equivalent to about 0.2 equivalent of metal cation per equivalent of (meth)acrylic acid monomer unit.

24. The article of claim 18, wherein the poly(ethylene-co-(meth)acrylic acid) ionomer has a 1% secant modulus according to ASTM D882-02 in a range of from about 40 MPa to about 500 MPa.

25. The article of claim 18, wherein the poly(ethylene-co-(meth)acrylic acid) ionomer has a 1% secant modulus according to ASTM D882-02 in a range of from about 100 MPa to about 400 MPa.

26. The article of claim 18, wherein the poly(ethylene-co-(meth)acrylic acid) ionomer has a 1% secant modulus according to ASTM D882-02 in a range of from about 150 MPa to about 300 MPa.

27. The article of claim 18, wherein the electret film comprises a polymer blend.

28. The article of claim 18, wherein the electret film further comprises a filler.

29. The article of claim 18, wherein the electret film further comprises at least one of a heat stabilizer or a light stabilizer.

30. The article of claim 18, wherein the first substrate comprises a backing sheet.

31. The article of claim 18, wherein the article is in the form of a roll.

32. The article of claim 18, wherein the article is in the form of a sheet.

33. The article of claim 18, wherein the first substrate is selected from the group consisting of a backing sheet, an architectural surface, a window, and a motor vehicle.

34. An article comprising:
an electret film having first and second opposed major surfaces, the electret film comprising a poly(ethylene-co-(meth)acrylic acid) ionomer;
a first substrate; and
a second substrate,
wherein the first major surface of the electret film is electrostatically and removably adhered to the first substrate, and wherein the second major surface of the electret film is adhered to the second substrate.

35. The article of claim 34, wherein second major surface of the electret film is electrostatically and removably adhered to the second substrate.

36. The article of claim 35, wherein the first substrate is selected from the group consisting of a backing sheet, an architectural surface, a window, and a motor vehicle.

37. The article of claim 36, wherein the second substrate comprises at least one of paper, glass, or a thermoplastic film.

38. The article of claim 38, wherein the second substrate comprises an optical film.

39. The article of claim 38, wherein the first major surface of the electret film has a graphic image thereon.

40. The article of claim 38, wherein the second major surface of the electret film has a graphic image thereon.

41. A method for adhering a film to a substrate comprising:
providing an electret film having first and second opposed major surfaces, the electret film comprising a poly(ethylene-co-(meth)acrylic acid) ionomer;
providing a substrate having a surface; and
electrostatically and removably adhering the first major surface of electret film to the surface of the substrate, wherein the substrate is selected from the group consisting of a backing sheet, a multilayer optical film, a ceiling, a wall, a floor, a window, a mirror, drywall, plaster, a motor vehicle, a trailer, a mobile home, a boat, furniture, a box, a cabinet, a door, ceramic tile, a banner, a balloon, a sign, paper, and cloth.

42. An article comprising:
an electret film having first and second opposed major surfaces, the electret film comprising a poly(ethylene-co-(meth)acrylic acid) ionomer; and
a substrate, wherein the first major surface of the electret film is electrostatically and removably adhered to the substrate, wherein the substrate is selected from the group consisting of a backing sheet, a multilayer optical film, a ceiling, a wall, a floor, a window, a mirror, drywall, plaster, a motor vehicle, a trailer, a mobile home, a boat, furniture, a box, a cabinet, a door, ceramic tile, a banner, a balloon, a sign, paper, and cloth.
